(19) United States
(12) Patent Application Publication
(10) Pub. No.: US 2005/0122519 A1
(43) Pub. Date: Jun. 9, 2005

(54) Fluorescent auxiliary testing apparatus

(76) Inventors: Jau-Jiu Ju, Hsinchu (TW); Yuan-Chin Lee, Hsinchu (TW); K. C. Chin, Hsinchu (TW); Kuang-Wu Hsu, Hsinchu (TW); Chen-I Kuo, Hsinchu (TW); Hae-Ruoh Huang, Hsinchu (TW); Yueh-Hsuan Tsai, Hsinchu (TW)

Correspondence Address: BIRCH STEWART KOLASCH & BIRCH, PO BOX 747, FALLS CHURCH, VA, 22040-0747, US

(21) Appl. No.: 10/826,257

(22) Filed: Apr. 19, 2004

(30) Foreign Application Priority Data
Dec. 9, 2003 (TW) 092134742

(51) Int. Cl. G01N 21/64

(52) U.S. Cl. 356/417

(57) ABSTRACT

A fluorescent auxiliary testing apparatus includes a light source module which emits a laser light to pass through a collimator, a dichroic mirror, and a first converging lens to project a testing object. The testing object emits a corresponding testing fluorescent light which passes through a filter assembly and a second converging lens and is received by a photo detector for generating a photoelectric signal. The photoelectric signal is transferred to a data processing equipment to perform test and analysis processes. The apparatus has a small size and a simple structure, and may be fabricated at a low cost.

### FIELD OF THE INVENTION

The present invention relates to an auxiliary testing apparatus adopted for use in the biomedical field and particularly to a fluorescent auxiliary testing apparatus that has a simple structure and a small size, and may be fabricated at a low cost.

### BACKGROUND OF THE INVENTION

The biomedical technology has had great advances in recent years. New innovations and breakthroughs appear constantly. With thriving of semiconductor industries, research and development of related electronic elements also have great progress. As a result, biomedical research also advances significantly.

Testing technology is one of the focused areas in biomedical research. Conventional testing methods generally include to placing a bio-chip set on an optical disk that has a data layer and projecting a light of a selected wavelength. An optical reader is used to read the fluorescent signals emitted by the bio-chip set and data layer signals of the optical disk. Finally a data processing unit is employed to process the fluorescent signals and the data layer signals, and rebuild the fluorescent signals of the bio-chip set in a two dimensional format. Reference can be found in U.S. Pat. No. 6,320,660.

Besides the testing method mentioned above, electrophoresis (EP) is a technique widely used to do various types of tests. Its basic principle is that any substance that is ionized by itself or by absorbing other charged particles will moves towards a selected electrode in an electric field. The charged particle may be a small ion, or a larger bio molecule such as protein, nucleic acid, virus, or the like. For instance, the amino acids of the protein are bi-character substances. They can be ionized and charged in a selected pH condition to become a source of electric charge. The charged particle may move to an electrode of an opposite electric polarity in an electric field. This phenomenon is called ‘electrophoresis’.

In the testing areas such as in the biomedicine, the principle of electrophoresis is widely adopted. When a capillary containing a testing object is subject to a high voltage, an electrophoresis phenomenon takes place. The deoxyribonucleic acid (DNA) of the testing object may be coupled with a fluorescent additive. When projected by a light source such as laser, fluorescent lights with different wavelengths will be generated. Then gene characteristics and concentration data of the testing object may be obtained, and test analysis reports may be generated for research and development use.

However, the fluorescent testing apparatus required for capillary electrophoresis gene analysis usually have a complex design and are quite bulky. They are very expensive and maintenance costs also are high. As research organizations generally have procurement budget constraint, it becomes a big concern. This is a problem, which still has to be overcome.

### SUMMARY OF THE INVENTION

Therefore the present invention aims to provide a fluorescent auxiliary testing apparatus that has a simple structure and a small size, and adopts a modular design and can perform tests simultaneously for a plurality of testing objects and is inexpensive.

The fluorescent auxiliary testing apparatus according to the invention mainly includes a light source module, a collimator, a dichroic mirror, a first converging lens, a filter assembly, a second converging lens and a photo detector. The light source module is for emitting laser light. The collimator is located on one side of the light source module to receive and transform the laser light so that it travels in a parallel fashion. The dichroic mirror is located on one side of the collimator and forms 45° against the parallel traveling direction of the laser light to reflect the laser light. The first converging lens is located on one side of the dichroic mirror to focus and project the reflected laser light on a testing object which emits a corresponding testing fluorescent light.

Then the testing fluorescent light passes through the first converging lens and travels proximately in parallel to pass through the dichroic mirror. The filter assembly is located on one side of the dichroic mirror to receive the testing fluorescent light, passing through the dichroic mirror and blocking scattering lights, to keep the wavelengths of the passed fluorescent light in a selected range. The second converging lens is to converge and focus the filtered fluorescent light. Finally the photo detector on one side of the second converging lens receives the filtered testing fluorescent light and transforms it to photoelectric signals. The photoelectric signals may be transformed to digital signals through a photoelectric signal converter. The transformed digital signals are transferred to data processing equipment, such as a computer for a test analysis.

The fluorescent auxiliary testing apparatus according to the invention may be used on capillary electrophoresis gene analysis instruments, gene chip sets, protein chip sets and the like, that have a fluorescent light testing apparatus. It has a small size and simple construction. It adopts a modular design and can perform testing for a plurality of testing objects simultaneously. The elements are easy to procure, thus production costs are lower.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the fluorescent auxiliary testing apparatus according to the invention.

FIG. 2 is a schematic view of the fluorescent auxiliary testing apparatus and photoelectric signal conversion module according to the invention.

FIG. 3 is a schematic view of a modular fluorescent auxiliary testing apparatus according to the invention in a use condition.

### DESCRIPTION OF THE PREFERRED EMBODIMENTS

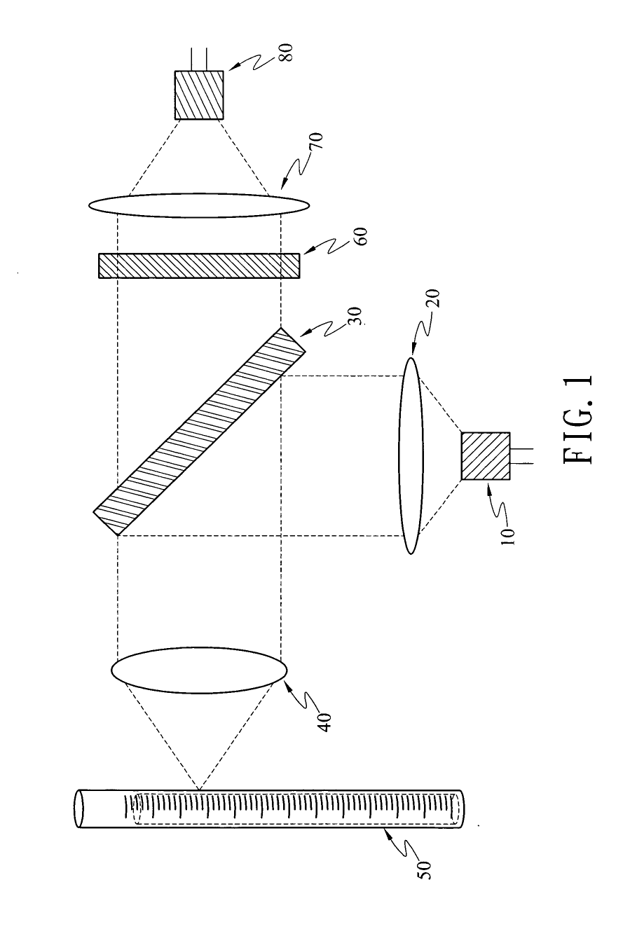

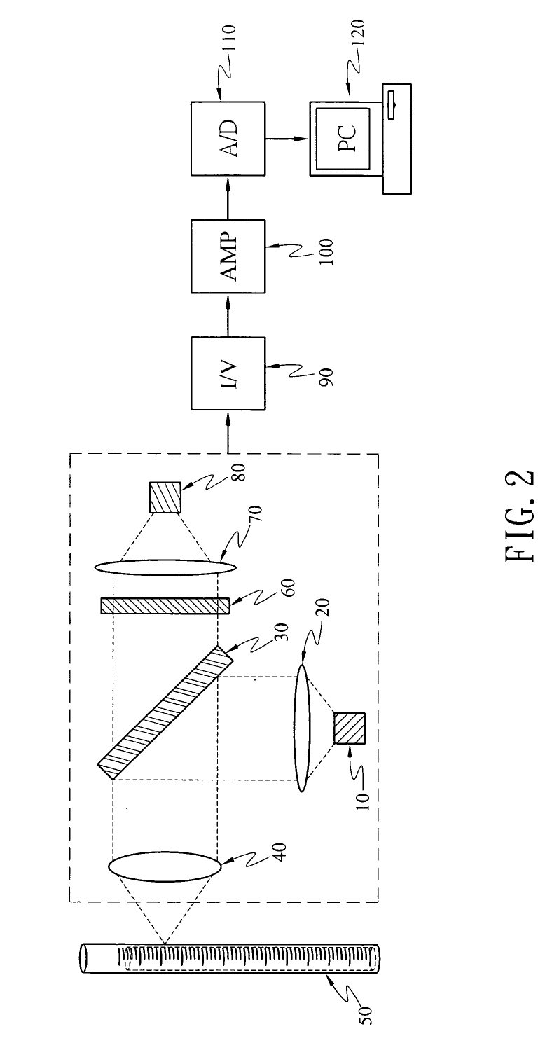

Referring to FIGS. 1 and 2, the fluorescent auxiliary testing apparatus according to the invention mainly includes a light source module 10, a collimator 20, a dichroic mirror 30, a first converging lens 40, a testing object 50, a filter assembly 60, a second converging lens 70 and a photo detector 80. The light source module 10 has many selections. Most products on the market adopt a gas laser and a mercury lamp that has a continuous light spectrum. However, those light source modules are expensive, and the mercury lamp has a short service life. Hence the invention suggests using a laser diode as the light source module 10 that has similar functions but is much cheaper. The light source module 10 is used to emit laser light. The collimator 20 is located on one side of the light source module 10 to receive and transform the laser light, so that the laser light may travel in a parallel way. The dichroic mirror 30 is located on one side of the collimator in a biased manner to reflect the parallel laser light. The dichroic mirror 30 has different characteristics and biased angles depending on its product specifications. The invention employs a double-wavelength dichroic mirror which has a receiving flat surface forming 45° against the incident direction of the laser light. The first converging lens 40 is an aspheric objective lens and located on one side of the dichroic mirror 30 and on the optical path of the reflected laser light to focus and project the refracted laser light on the testing object 50. In this embodiment, the testing object 50 is subject to an external high voltage to generate an electrophoresis phenomenon for the substance filled inside so that a corresponding testing fluorescent light is emitted after having received laser light projection. Namely, the testing object 50 will generate Stoke's Shift after being projected by the laser light. The testing fluorescent light being emitted has a wavelength greater than the laser light. The testing fluorescent light passes through the first converging lens 40 and travels substantially in nearly parallel to pass through the dichroic mirror 30.

The filter assembly 60 is located on another side of the dichroic mirror to block scattering lights and background lights from entering, and allow only the testing fluorescent light of wavelengths of a selected range to pass through, thereby limiting the wavelength range of the testing florescent light to meet test requirements. The filter assembly 60, depending on test requirements, may consist of a plurality of optical band pass filters. In general, the flat surface of the filter assembly 60 that receives the testing fluorescent light forms an angle of 90° against the incident direction of the testing fluorescent light. The second converging lens 70 is an aspheric object lens and located on one side of the filter assembly 60 to converge and focus the filtered testing fluorescent light of a selected wavelength range that has passed through the filter assembly 60. Finally the photo detector 80 located on one side of the second converging lens receives the filtered testing fluorescent light and transforms it to photoelectric signals. The photo detector 80 may be substituted by many other devices of similar functions such as a photo-multiplier tube or low noise photo diodes, and the like. As the photo-multiplier tube is bulky and expensive, low noise photo diodes that have a lower operation voltage, a longer service life and a lower price, are preferred choices.

Referring to FIG. 2, as the photoelectric signals provided by the photo detector 80 cannot be directly read by a data processing equipment 120, an additional photoelectric signal conversion module has to be employed. The photoelectric signal conversion module consists of a photo signal conversion unit 90, an amplifier 100 and an analog to digital signal conversion unit 110. The photo signal conversion unit 90 receives the photoelectric signals transferred from the photo detector 80 and transforms them to voltage signals. The amplifier 100 receives and amplifies the voltage signals, and finally the digital signal conversion unit 110 transforms the voltage signals to digital signals, which are received by the selected data processing equipment such as a computer or electrophoresis gene analysis device, to perform tests and analyses for the testing fluorescent light emitted from the testing object 50.

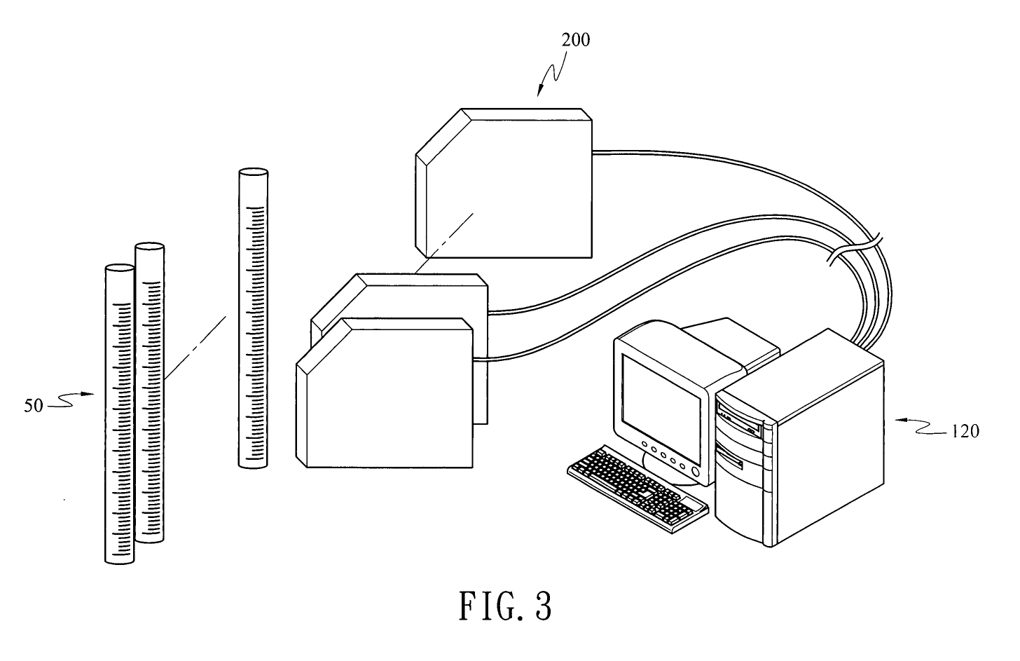

The fluorescent auxiliary testing apparatus according to the invention may adopt a modular design as shown in FIG. 3. The elements set forth above may be packaged in a mechanism to form a modular fluorescent auxiliary testing apparatus 200, to perform fluorescent light tests and analyses simultaneously, for a plurality of testing objects 50. The resulting data may be transferred to the data processing equipment 120, to perform tests and analysis processes.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

1. A fluorescent auxiliary testing apparatus for projecting a testing object and receiving a corresponding testing fluorescent light emitted from the testing object, comprising:
a light source module for emitting a laser light;
a collimator located on one side of the light source module to receive and transform the laser light so that the laser light travels in a parallel fashion;
a dichroic mirror located on one side of the collimator to reflect the parallel laser light;
a first converging lens located on one side of the dichroic mirror to focus and project the reflected laser light on the testing object so that the testing object emits a corresponding testing fluorescent light which passes through the first converging lens and travels substantially in a nearly parallel fashion to pass through the dichroic mirror;
a filter assembly located on another side of the dichroic mirror to filter scattering lights and background lights and allow only the testing fluorescent light of wavelengths of a selected range to pass through;
a second converging lens located on one side of the filter assembly to converge and focus the testing fluorescent light of the selected wavelength range; and
a photo detector located on one side of the second converging lens to receive the focused testing fluorescent light and transform the focused testing fluorescent light to a photoelectric signal.

2. The fluorescent auxiliary testing apparatus of claim 1 further including a photoelectric signal conversion module which includes:
a photo signal conversion unit for receiving the photoelectric signal and transforming the photoelectric signal to a voltage signal;
an amplifier for receiving and amplifying the voltage signal; and
an analog to digital signal conversion unit for transforming the voltage signal to a digital signal.

3. The fluorescent auxiliary testing apparatus of claim 1, wherein the light source module is a laser diode.

4. The fluorescent auxiliary testing apparatus of claim 1, wherein the dichroic mirror has a flat surface to receive and reflect the laser light and form an angle of 45 degrees against the incident direction of the laser light.

5. The fluorescent auxiliary testing apparatus of claim 1, wherein the filter assembly has a flat surface to receive the testing fluorescent light and form an angle of 90 degrees against the incident direction of the testing fluorescent light.

6. The fluorescent auxiliary testing apparatus of claim 1, wherein the filter assembly is an optical band pass filter.

7. The fluorescent auxiliary testing apparatus of claim 1, wherein the dichroic mirror is a double-wavelength dichroic mirror.

8. A fluorescent auxiliary testing apparatus comprising a light source module, a collimator, a dichroic mirror, a first converging lens, a filter assembly, a second converging lens and a photo detector;
wherein the light source module emits a laser light which is received and transformed by the collimator to become a parallel laser light to travel forwards, the dichroic mirror reflects the laser light to the first converging lens which converges and focuses the laser light for projecting to a testing object so that the testing object emits a corresponding testing fluorescent light which passes through the first converging lens to become substantially nearly parallel for traveling forwards and passing through the dichroic mirror and to be filtered by the filter assembly such that only the testing fluorescent light of a selected range of wavelengths passes through, and the second converging lens focuses the testing fluorescent light and transfers the testing fluorescent light to the photo detector which receives and transforms the testing fluorescent light to a photoelectric signal.

9. The fluorescent auxiliary testing apparatus of claim 8 further including a photoelectric signal conversion module which includes:
a photo signal conversion unit for receiving the photoelectric signal and transforming the photoelectric signal to a voltage signal;
an amplifier for receiving and amplifying the voltage signal; and
an analog to digital signal conversion unit for transforming the voltage signal to a digital signal.

10. The fluorescent auxiliary testing apparatus of claim 8, wherein the light source module is a laser diode.

11. The fluorescent auxiliary testing apparatus of claim 8, wherein the dichroic mirror has a flat surface to receive and reflect the laser light and form an angle of 45 degrees against the incident direction of the laser light.

12. The fluorescent auxiliary testing apparatus of claim 8, wherein the filter assembly has a flat surface to receive the testing fluorescent light and form an angle of 90 degrees against the incident direction of the testing fluorescent light.

13. The fluorescent auxiliary testing apparatus of claim 8, wherein the filter assembly is an optical band pass filter.

14. The fluorescent auxiliary testing apparatus of claim 8, wherein the dichroic mirror is a double-wavelength dichroic mirror.
